(19) United States
(12) Patent Application Publication
(10) Pub. No.: US 2013/0221697 A1
(43) Pub. Date: Aug. 29, 2013

(54) MULTI-FUNCTIONAL CARGO RETENTION NET

(71) Applicant: Robert Charles Steinbrecher, Dexter, MI (US)

(72) Inventor: Robert Charles Steinbrecher, Dexter, MI (US)

(73) Assignee: Toyota Motor Engineering & Manufacturing North America, Inc., Erlanger, KY (US)

(21) Appl. No.: 13/406,864

(22) Filed: Feb. 28, 2012

(51) Int. Cl. B60P 7/06

(52) U.S. Cl. 296/24.43

(57) ABSTRACT

A motor vehicle having a multi-functional cargo retention net system is provided. The system can include a motor vehicle with a cargo storage compartment that has a floor, a pair of spaced-apart sidewalls that extend upwardly from the floor, and a rear door that may or may not have a window. In addition, the cargo storage compartment has a cargo net with a first end that is attached at a central attachment position spaced apart from the floor and behind the row of passenger seats. The cargo net also has a second end that can be selectively attached at a top attachment position and a back attachment position, attachment at the top position providing a vertical divider between the luggage compartment and the passenger compartment and attachment at the back position providing a shelf and/or a horizontal cargo net extending across the floor.

### FIELD OF THE INVENTION

The present invention is related to a cargo retention net system for a motor vehicle and, in particular, to a multi-functional cargo retention net system for a motor vehicle.

### BACKGROUND OF THE INVENTION

Motor vehicles that have a passenger compartment with a luggage compartment behind a row of passenger seats are well known. In addition, the luggage compartment has a floor and can have a cargo net that allows for restraining of luggage, groceries, and the like within the luggage compartment. However, in some instances a vertical divider between the passenger compartment and the luggage compartment is desirable, and even though vertical dividers are known, such systems function only as a vertical divider or are part of a complex two-panel system. Therefore, a simple multi-functional cargo retention net system that allows a user of a motor vehicle to use a single cargo net to extend vertically and separate the luggage compartment from the passenger compartment in the motor vehicle or extend horizontally across the floor of the luggage compartment would be desirable.

### SUMMARY OF THE INVENTION

A motor vehicle having a multi-functional cargo retention net system is provided. The system can include a motor vehicle with a cargo storage compartment, also known as a luggage compartment, that is separated from a passenger compartment by a row of passenger seats. The cargo storage compartment has a floor, a pair of spaced-apart sidewalls that extend upwardly from the floor, and a rear door that may or may not have a window. In addition, the cargo storage compartment has a cargo net with a first end that is attached at a central attachment position spaced apart from the floor and behind the row of passenger seats.

The pair of spaced-apart sidewalls of the cargo storage compartment can have a top attachment position that is located vertically above the central attachment position and a back attachment position that is located horizontally and spaced apart from the central attachment position. The cargo net has a second end that is operable to selectively attach to the top attachment position and the back attachment position.

When the second end of the cargo net is attached to the top attachment position, a generally vertical cargo net that can serve of afford a division or divider between the cargo storage compartment and the seating area of the motor vehicle is provided. In the alternative, when the second end of the cargo net is attached to the back attachment position, the cargo net can serve as a shelf as it extends generally horizontal across the cargo storage compartment. In addition, the motor vehicle can have a rear window and the generally horizontal cargo net can be out of a line-of-sight between a driver of the motor vehicle and the rear window and/or out of a line-of-sight between a rear view mirror and the rear window. In some instances, the central attachment position can be part of a cargo net retraction system that may or may not have a spring that applies tension on the cargo net when the second end is selectively attached to the top attachment position and the back attachment position.

A process for using a motor vehicle cargo retention net in a multi-functional manner is also provided. The process includes providing the motor vehicle with the multi-functional cargo retention net system described above and attaching the second end of the cargo net to the vertical attachment structure in order to provide a vertical divider between the cargo storage compartment and the passenger compartment of the motor vehicle. In addition, the process includes attaching the second end of the cargo net to the horizontal attachment structure in order to provide a horizontal retention net extending over the floor of the cargo storage compartment which can secure components, packages, etc., within the cargo storage compartment and optionally be used as a shelf on which one or more items can be placed on.

### BRIEF DESCRIPTION OF THE DRAWINGS

FIG. 1 is a perspective view of a motor vehicle having a rear cargo storage compartment behind a row of passenger seats with a cargo retention net in a generally vertical orientation;

FIG. 2 is a perspective view of the motor vehicle shown in FIG. 1 with the cargo net in a generally horizontal position;

FIG. 3 is a cutaway view of a portion of FIG. 2 illustrating movement of the cargo net from the generally horizontal position to the generally vertical position;

FIG. 4 is a side cross-sectional view of a cargo net retraction system according to an embodiment of the present invention; and

FIG. 5 is a side view of the motor vehicle shown in FIGS. 1 and 2 with the cargo net in a generally horizontal position and illustrating that the cargo net is out of a line-of-sight between a driver of the motor vehicle, a rearview mirror, and a rear window of the motor vehicle.

### DETAILED DESCRIPTION OF THE PRESENT INVENTION

The present invention provides a multi-functional cargo retention net system for a motor vehicle. As such, the present invention has utility as a component for a motor vehicle.

A motor vehicle having a cargo storage compartment behind a passenger compartment and a row of passenger seats can be included and the cargo storage compartment can have a floor with a pair of spaced-apart sidewalls extending upwardly from the floor. A cargo net can also be included and have a first end attached at a central attachment position that is spaced apart from the floor and typically directly located behind the row of passenger seats. The cargo net also has a second end that is spaced apart from the first end.

The cargo storage compartment can also have at least two attachment positions for the second end of the cargo net to attach thereto such that the cargo net extends in a generally vertical orientation or a generally horizontal orientation. In particular, the pair of spaced-apart sidewalls can have a top or vertical attachment position that is located vertically above the central attachment position and a back, rearward, or horizontal attachment position located generally horizontal to and spaced apart from the central attachment position. With the top and back attachment positions, the second end of the cargo net can be selectively attached at or to either position and a generally vertical divider between the cargo storage compartment and the passenger compartment or a generally horizontal cargo net extending over the cargo storage compartment can be provided. In this manner, a single cargo net can be used to provide a vertical divider between different areas or portions of a motor vehicle, or in the alternative, to hold components, groceries, etc. on the floor of the cargo storage compartment. In addition, the cargo net can serve as a generally horizontal shelf when the second end of the net is attached to the back attachment position.

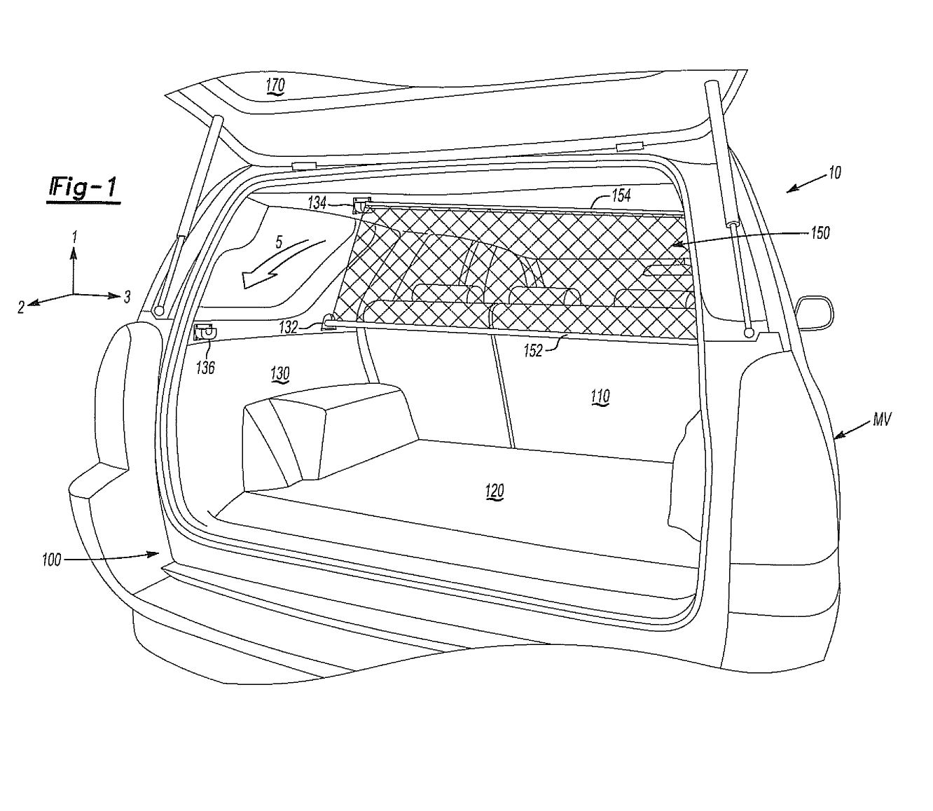

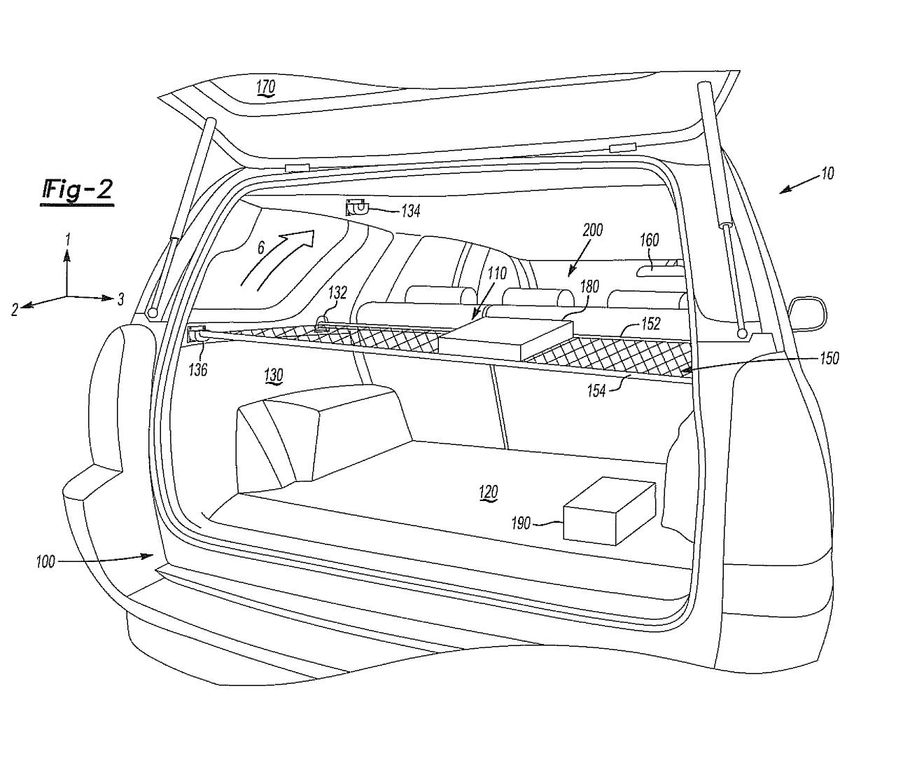

Turning now to FIG. 1, an embodiment of the multi-functional cargo retention net system is shown generally at reference numeral 10. The system 10 can include a motor vehicle MV that has a cargo storage compartment 100 and a row of passenger seats 110. It is appreciated that a passenger compartment 200 is located in front of the cargo storage compartment (see FIG. 2) as is known to those skilled in the art. The cargo storage compartment 100 also includes a floor 120 and a pair of spaced-apart sidewalls 130 extending upwardly from the floor 120.

Each of the sidewalls 130 can have a central attachment position 132, a top or vertical attachment position 134, and a back or horizontal attachment position 136. It is appreciated that even though only one sidewall 130, central attachment position 132, top attachment position 134 and back attachment position 136 is shown in the figure, a corresponding sidewall, central attachment position, etc., is present on an opposite side of the cargo storage compartment 100 as is known to those skilled in the art.

Also included in the system 10 is a cargo net 150 having a first end 152 and a second end 154. It is appreciated that the second end 154 can be spaced apart from the first end 152 when the first end 152 is held at a fixed location and a force is applied to the second end 154 in a direction away from the first end 152. In some instances, the central attachment position 132 can be a fixed attachment position in which the first end 152 is permanently attached at this location, however this is not required. It is appreciated that the term “permanently attached” refers to attachment of the first end 152 to the sidewalls 130 using an attachment, fastener, and the like which requires the use of a hand tool or some other process that is typically performed by a mechanic. Stated differently, such a permanent attachment is one not typically operable for an owner of the vehicle to be able to remove the first end 152 of the cargo net 150 from the central attachment position 132. In the alternative to a permanent attachment, the attachment position or structure 132 can be a releasable attachment position in which a snap, hook-and-loop fastener, tongue-and-groove structure, U-shaped flange for accepting a rod, and the like is present and a typical owner of the motor vehicle MV can releasably attach the first end 152 to the central position 132 and remove it therefrom when desired.

As shown in FIG. 1, the first end 152 of the cargo net 150 extends along a generally horizontal direction 3 and the second end 154 can be attached to the top attachment position 134 to provide a generally vertical cargo net that extends in a generally vertical direction 1. In this manner, a vertical divider between the cargo storage compartment 100 and the passenger compartment 200 located in front of the row of passenger seats 110 is afforded. In addition, and as shown by the arrow 5 in FIG. 1 and illustrated by the cargo net 150 in FIG. 2, the cargo net 150 can have its second end 154 attached to the back attachment position 136 such that the net 150 extends in a generally horizontal direction 2. Thus the cargo net 150 can also extend horizontally across the floor 120 and cargo storage compartment 100.

It is appreciated that the physical dimensions of the cargo net 150 are such that extension of the net and attachment of the second end 154 to the top attachment position 134 and/or the back attachment position 136 provides a generally taut net. As such, when the cargo net 150 is in its generally horizontal orientation as shown in FIG. 2, the net 150 can serve as a shelf in which one or more components, packages, etc. 180 can be located thereon. In addition, the generally horizontal cargo net 150 can ensure that one or more components, packages, etc. 190 located within the cargo storage compartment stay behind the row of passenger seats 110 in the event of rapid braking of the motor vehicle MV, a motor vehicle accident, and the like.

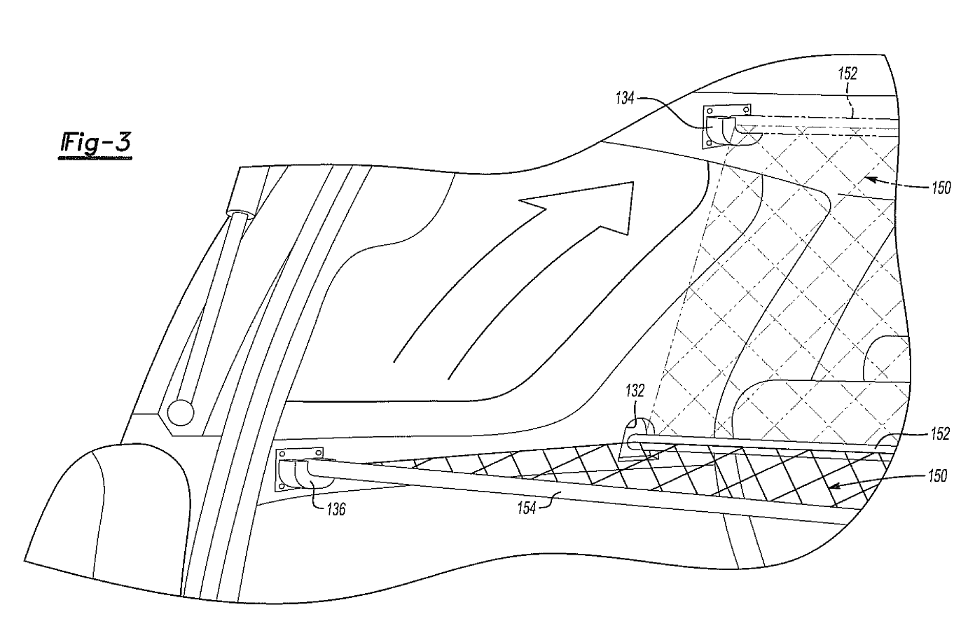

Turning now to FIG. 3, an enlarged view of the top attachment position 134 and the back attachment position 136 is shown. The top attachment position 134 can have any attachment mechanism known to those skilled in the art, illustratively including a tab or flange to which the second end 152 of the cargo net 150 can engage such that the net 150 is held in a generally vertical orientation or horizontal orientation as desired.

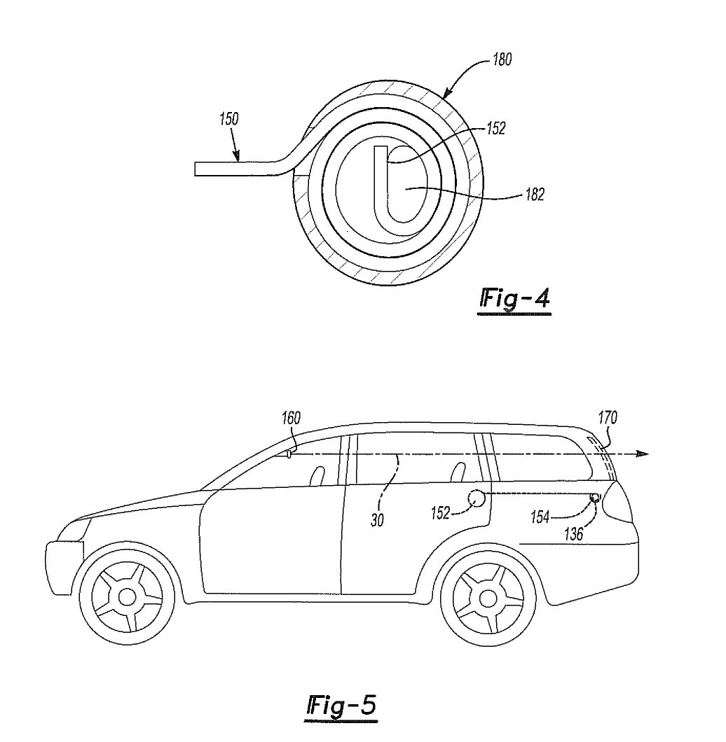

The central attachment position 132 and/or cargo net 150 can have a cargo net retraction system 180 as illustrated in FIG. 4 that provides for retraction of the net when the second end 154 is not attached to the top attachment position 134 or the back attachment position 136. Such a cargo net retraction system 180 can include the first end 152 of the cargo net 150 attached to a central rod or axis 182 and a tensioning device such as a spring (not shown) that affords for winding up of the net 150. It is appreciated that the cargo net retraction system 180 can be automatic, that is the cargo net 150 is retracted when not in use, or can be semi-automatic in that the net 150 is not retracted unless the system 180 is activated by a user.

Turning to FIG. 5, the orientation of the cargo net 150 in the generally horizontal position affords for a clear line-of-sight between a driver of the motor vehicle and a rear window 170 thereof. In addition, the clear line-of-sight can also be present when the driver of the motor vehicle is viewing out of the rear window 170 with the aid of a rearview mirror 160 as indicated by the dotted line 30. It is also appreciated that the cargo net 150, being a cargo net with a plurality of spaced-apart fibers, cords, etc., has openings therebetween and when in the generally vertical orientation as taught in FIG. 1 does allow some viewing therethrough.

A process for using a cargo retention net in a multi-functional manner includes providing a motor vehicle with a cargo net and attachment positions as disclosed above and selectively attaching the second end 154 of the cargo net 150 to the top attachment position or structure 134 and the back or horizontal attachment position or structure 136. Stated differently, depending upon the desired function of the cargo net 150, the net 150 can be used as a vertical divider between a cargo storage compartment and a passenger compartment of a motor vehicle, as a shelf for holding one or more components and/or as a retaining net for holding one or more components, packages, etc. in a secure location on a floor of the cargo storage compartment. As such, a single cargo net can be used in a multi-functional manner.

It is appreciated from the teachings above that specific embodiments of the multi-functional cargo retention net system have been described but that the scope of the invention is not limited by the embodiments. In addition, one skilled in the art will be aware of changes, alterations, etc. based on the teachings herein that fall within the scope of the invention. As such, the scope of the invention is provided by the claims and all equivalents thereof.

I claim:

1. A motor vehicle having a multi-functional cargo retention net system comprising:
a motor vehicle having a cargo storage compartment behind a row of passenger seats, said cargo storage compartment having a floor and a pair of spaced-apart sidewalls extending upwardly from said floor, said cargo storage compartment also having a cargo net with a first end attached at a central attachment position spaced apart from said floor;
said pair of spaced-apart sidewalls having a top attachment position located vertically above said central attachment position and a back attachment position located horizontally and spaced apart from said central attachment position; and
said cargo net having a second end operable to selectively attach to said top attachment position and said back attachment position.

2. The motor vehicle of claim 1, wherein said cargo net with said second end attached to said top attachment position is a generally vertical cargo net and a divider between said cargo storage compartment and a seating area of said motor vehicle.

3. The motor vehicle of claim 2, wherein said cargo net with said second end attached to said back attachment position is a shelf with a generally horizontal cargo net extending over said cargo storage compartment.

4. The motor vehicle of claim 3, wherein said motor vehicle has a rear window and said generally horizontal cargo net is out of a line-of-sight between a driver of said motor vehicle and said rear window.

5. The motor vehicle of claim 1, wherein said central attachment position is part of a cargo net retraction system.

6. The motor vehicle of claim 5, wherein said cargo net retraction system has a spring that applies tension on said cargo net when said second end is selectively attached to said top attachment position and said back attachment position.

7. A motor vehicle having a multi-functional cargo retention net system comprising:
a motor vehicle having a cargo storage compartment located behind a row of passenger seats, said cargo storage compartment having a floor and a pair of spaced-apart sidewalls extending upwardly from said floor;
said cargo storage compartment having a first attachment structure located behind said row of passenger seats and above said floor at a first predetermined height, a second attachment structure located vertically above said first attachment structure at a second predetermined height, and a third attachment structure spaced rearwardly from said first attachment structure and spaced above said floor at said first predetermined height; and
a cargo net having a first end attached to said first attachment structure and a second end selectively attachable to said second attachment structure and said third attachment structure;
said first, second and third attachment structures operatively arranged for the cargo net to provide a generally vertical cargo net divider between said row of passenger seats and said cargo storage compartment when said cargo net second end is attached to said second attachment structure and to provide a generally horizontal cargo net extending across said floor of said cargo storage compartment when said cargo net second end is attached to said third attachment structure.

8. The motor vehicle of claim 7, wherein a distance between said first attachment structure and said second attachment structure is generally equal to a length of said cargo net.

9. The motor vehicle of claim 7, wherein a distance between said first attachment structure and said third attachment structure is generally equal to a length of said cargo net.

10. The motor vehicle of claim 7, wherein said motor vehicle has a rear window and said generally horizontal cargo net is out of a line-of-sight between a driver of said motor vehicle and said rear window.

11. The motor vehicle of claim 7, wherein said first attachment position is part of a cargo net retraction system.

12. The motor vehicle of claim 11, wherein said cargo net retraction system has a spring that applies tension on said cargo net when said second end is selectively attached to said second attachment position and said third attachment position.

13. A process for using a motor vehicle cargo retention net in a multi-functional manner, the process comprising:
providing a motor vehicle having a storage compartment with a floor and a cargo net, the storage compartment located behind a passenger compartment and the cargo net having a first end and a second end;
providing a multi-functional attachment structure for the cargo net;
the multi-functional attachment structure having a first end attachment structure, a vertical attachment structure and a horizontal attachment structure, the first end attachment structure located a first predetermined distance from the floor and having the first end of the cargo net attached thereto;
the vertical attachment structure being located vertically above and spaced apart from the first end attachment structure and the horizontal attachment structure located horizontal to and spaced apart from the first end attachment structure;
attaching the second end of the cargo net to the vertical attachment structure and providing a vertical divider between the storage compartment and the passenger compartment; and
attaching the second end of the cargo net to the horizontal attachment structure and providing a horizontal retention net extending over the floor of the storage compartment.

14. The process of claim 13, wherein providing the vertical divider between the storage compartment and the passenger compartment prevents cargo from leaving the storage compartment and entering the passenger compartment.

15. The process of claim 13, wherein providing the horizontal retention net extending over the floor of the storage compartment provides shelving for the storage compartment.

16. The process of claim 13, wherein providing the horizontal retention net extending over the floor of the storage compartment provides increased visibility for a driver of the motor vehicle when compared to the vertical divider being provided.
